(19) United States
(12) Patent Application Publication
(10) Pub. No.: US 2011/0115281 A1
(43) Pub. Date: May 19, 2011

(54) BRAKE CONTROL APPARATUS OF HYBRID VEHICLE, AND METHOD THEREOF

(75) Inventor: Gab Bae JEON, Hwaseong-si (KR)

(73) Assignees: Hyundai Motor Company, Seoul (KR); Kia Motors Corporation, Seoul (KR)

(21) Appl. No.: 12/847,752

(22) Filed: Jul. 30, 2010

(30) Foreign Application Priority Data
Nov. 19, 2009 (KR) 10-2009-0112247

(51) Int. Cl. B60T 13/74; B60T 13/66; B60T 13/10; B60L 7/10

(52) U.S. Cl. 303/3

(57) ABSTRACT

A braking control method of a braking control apparatus for a hybrid vehicle, may include accumulating a brake fluid amount bypassed to a reservoir tank during regenerative braking cooperation control performed by a brake demand, finishing the regenerative braking cooperation control when the accumulated brake fluid amount surpasses a predetermined value, and resetting the accumulated brake fluid amount when a brake pedal is released and a predetermined time elapses.

### CROSS-REFERENCE TO RELATED APPLICATION

The present application claims priority to Korean Patent Application No. 10-2009-0112247 filed in the Korean Intellectual Property Office on Nov. 19, 2009, the entire contents of which is incorporated herein for all purposes by this reference.

### BACKGROUND OF THE INVENTION

1. Field of the Invention

The present invention relates to a hybrid vehicle. More particularly, the present invention relates to a braking control apparatus of a hybrid vehicle sustaining a secure braking force during regenerative braking cooperation control, and a method thereof.

2. Description of Related Art

If a brake is operated when driving a hybrid vehicle, a motor assisting an output torque of an engine performs regenerative braking and uses braking energy to charge a battery.

In this case, the total braking amount determined by a brake pedal stroke is divided into a regenerative braking amount of the motor and a wheel braking amount operated by hydraulic pressure supplied to a brake cylinder of each wheel.

While the regenerative braking is generated by the motor, a bypass valve disposed on a hydraulic unit is controlled to exhaust brake fluid within the brake cylinder to a reservoir tank.

As stated above, the bypass valve repeatedly exhausts the brake fluid to the reservoir tank by the repeated operation of the brake pedal during the regenerative braking cooperation control.

Accordingly, there will be a short supply of the brake fluid, and even though the brake pedal stroke is increased, the pressure of the brake cylinder is less than a predetermined level such that a secure braking force is not realized.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a braking control apparatus of a hybrid vehicle and a method thereof having advantages of procuring a stable braking performance during regenerative braking cooperation control.

In an aspect of the braking control apparatus of a hybrid vehicle, may include a master cylinder generating braking pressure in accordance with an operation of a brake pedal, a first valve controlling brake fluid supplied to a brake cylinder from the master cylinder, a second valve bypassing the brake fluid supplied to the brake cylinder to a reservoir tank so as to adjust a regenerative braking torque amount during regenerative braking cooperation control, and a brake control portion finishing the regenerative braking cooperation control, when an accumulated amount of brake fluid amount bypassed to the reservoir tank through the second valve surpasses a predetermined value during the regenerative braking cooperation control.

The predetermined value may be a minimum amount that sustains the pressure in the brake cylinder

The brake control portion may close the second valve so as to prevent the brake fluid supplied to the brake cylinder from being bypassed to the reservoir tank when the regenerative braking cooperation control is finished.

The brake control portion may determine the brake fluid amount bypassed to the reservoir tank by subtracting a fluid consumption amount corresponding to a pressure increase point of the brake cylinder from a fluid consumption amount corresponding to a pressure decrease point of the brake cylinder.

The brake control portion may reset the accumulated amount of the brake fluid amount when the brake pedal is released and a predetermined time elapses, wherein the brake control portion resets the accumulated amount of the brake fluid amount when a stroke increase amount of the brake pedal is less than a predetermined value.

In another aspect of the present invention, the braking control method of a braking control apparatus for a hybrid vehicle, may include: accumulating a brake fluid amount bypassed to a reservoir tank during regenerative braking cooperation control performed by a brake demand, finishing the regenerative braking cooperation control when the accumulated brake fluid amount surpasses a predetermined value, and resetting the accumulated brake fluid amount when a brake pedal is released and a predetermined time elapses, wherein the braking control apparatus may have a master cylinder generating braking pressure in accordance with an operation of the brake pedal, a first valve controlling brake fluid supplied to a brake cylinder from the master cylinder, a second valve bypassing the brake fluid supplied to the brake cylinder to the reservoir tank so as to adjust a regenerative braking torque amount during the regenerative braking cooperation control, and a brake control portion finishing the regenerative braking cooperation control, when the accumulated brake fluid amount bypassed to the reservoir tank through the second valve surpasses the predetermined value during the regenerative braking cooperation control.

The predetermined value may be a minimum amount that sustains the pressure in the brake cylinder

The bypassed brake fluid amount may be determined by subtracting a fluid consumption amount corresponding to a pressure increase point of the brake cylinder from a fluid consumption amount corresponding to a pressure decrease point of the brake cylinder.

The brake control portion may close the second valve so as to prevent the brake fluid supplied to the brake cylinder from being bypassed to the reservoir tank when the regenerative braking cooperation control is finished.

The brake control portion may reset the accumulated brake fluid amount when a stroke increase amount of the brake pedal is less than a predetermined value.

In the hybrid vehicle according to the present invention, a stable braking force is secured such that stability and reliability when driving the hybrid vehicle are improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 shows a braking control apparatus of a hybrid vehicle according to an exemplary embodiment of the present invention.

FIG. 2 is a flowchart showing a braking control procedure of a hybrid vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

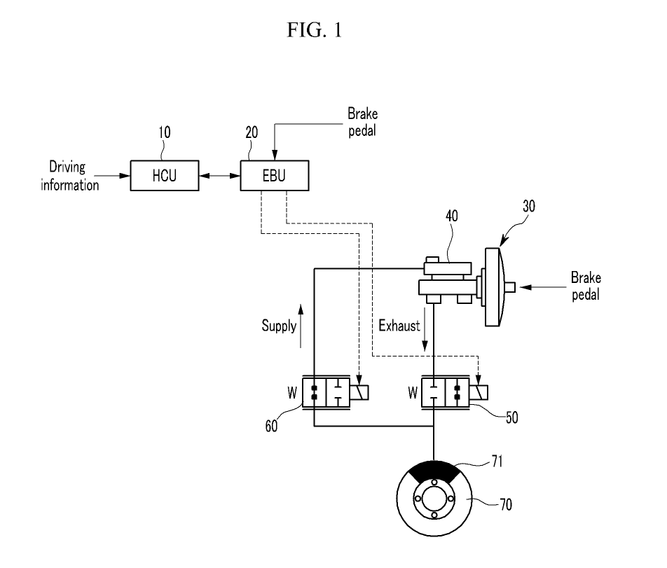

FIG. 1 shows a braking control apparatus of a hybrid vehicle according to an exemplary embodiment of the present invention.

The present invention includes a hybrid control unit (HCU) 10, an electronic brake unit (EBU) 20, a master cylinder 30, a reservoir tank 40, a first valve 50, a second valve 60, a wheel 70, and a brake cylinder 71.

The HCU 10 connects control devices that constitute a hybrid vehicle through a network to manage regenerative braking cooperation control and movement of a vehicle.

The EBU 20 is connected to the HCU 10 through a network to exchange control information and analyzed data, and if an “on” signal of a brake pedal is detected, determines a braking force according to a stroke of the brake pedal and operates the first valve 50 to adjust a brake fluid amount supplied to the brake cylinder 71.

Also, the EBU 20 operates the second valve 60 according to the regenerative braking torque during the regenerative braking cooperation control to bypass the brake fluid supplied to the brake cylinder 71 to the reservoir tank 40, and increases the regenerative braking torque amount.

Further, in a process of the regenerative braking cooperation control, the brake fluid amount bypassed to the reservoir tank 40 through the second valve 60 is detected, and if the detected fluid amount exceeds a predetermined value, the regenerative braking cooperation control is ended, and the second valve 60 is closed to prevent the brake fluid supplied to the brake cylinder 71 from being bypassed to the reservoir tank 40 such that a steady brake fluid amount is sustained to secure a stable braking force.

The master cylinder 30 pressurizes the brake fluid depending on the brake pedal signal to supply the brake cylinder 71 with the brake fluid through the first valve 50.

The reservoir tank 40 stores the brake fluid bypassed from the brake cylinder 71 through the second valve 60, and if the brake pedal is again pushed after releasing it, the stored brake fluid is supplied to the master cylinder 30.

The first valve 50 is operated by the EBU 20, and controls the brake fluid supplied to the brake cylinder 71 to adjust a braking force.

The second valve 50 is run by the EBU 20 during the regenerative braking cooperation control and bypasses the brake fluid supplied to the brake cylinder 71 to adjust the regenerative braking torque amount.

The brake cylinder 71 uses a pressure of the brake fluid supplied by the first valve 50 to generate a braking force at the wheel 70.

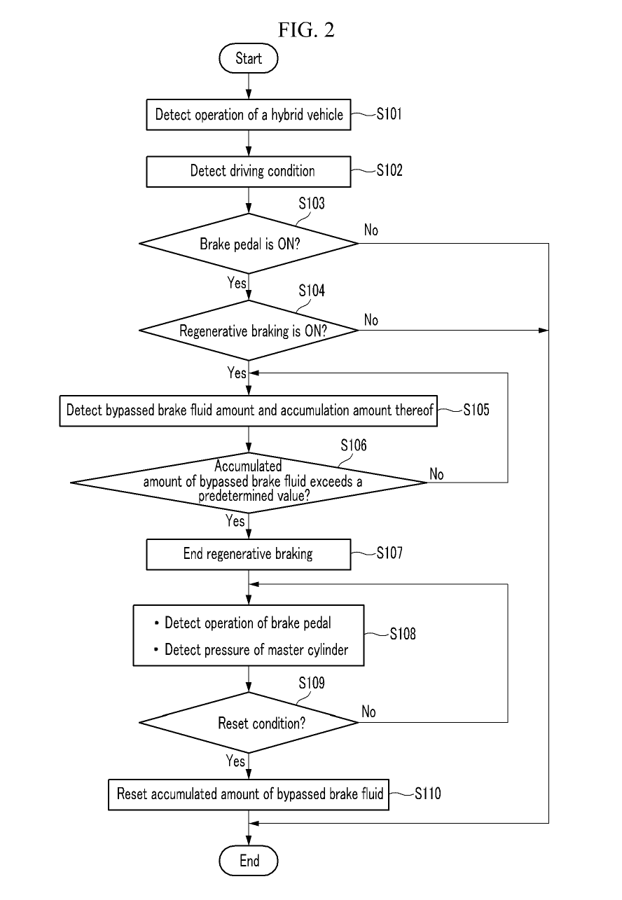

Referring to FIG. 2, the operation of the present invention including the above functions will be explained as follows.

FIG. 2 is a flowchart showing a braking control procedure of a hybrid vehicle according to an exemplary embodiment of the present invention.

In a condition in which a hybrid vehicle is being operated according to an exemplary embodiment of the present invention (S101), each control devices detects a driving condition to operate the function (S102).

Here, the EBU 20 determines whether brake control is being operated from a brake pedal to decelerate or stop the vehicle (S103).

If the brake pedal is off in S103, the present driving condition is sustained, and if the brake pedal is on and braking is performed, the first valve 50 is operated according to a braking force to control the brake fluid supplied to the brake cylinder 71.

Accordingly, the brake cylinder 71 applies friction to the wheel 70 to generate a braking force according to a brake fluid amount supplied thereto.

In a condition in which braking control is being operated according to a brake pedal signal, it is determined whether the motor is performing regenerative braking (S104).

If the regenerative braking cooperation control is not performed in S104, the brake cylinder 71 only performs braking control, and if the regenerative braking cooperation control is being performed, the second valve 60 is operated according to the regenerative braking torque and bypasses the brake fluid supplied to the brake cylinder 71 to the reservoir tank 40 to adjust the regenerative braking amount.

Since a total braking amount is calculated by adding a hydraulic braking amount to a motor regenerative braking amount, if the regenerative braking amount increases, the hydraulic braking amount decreases accordingly, and ultimately the brake fluid supplied to the brake cylinder 71 through the second valve 60 is bypassed to the reservoir tank 40.

The brake fluid amount bypassed to the reservoir tank 40 by the second valve 60 is accumulated in S105, and it is determined if the accumulated amount of the bypassed brake fluid exceeds a predetermined value which is a minimum amount that can normally sustain the pressure of the brake cylinder in S106.

The brake fluid amount bypassed to the reservoir tank 40 is calculated by subtracting a fluid consumption amount corresponding to a pressure increase point of the brake cylinder 71 from a fluid consumption amount corresponding to a pressure decrease point of the brake cylinder 71.

In a decision of S106, if the brake fluid amount bypassed to the reservoir tank 40 through the second valve 60 exceeds a predetermined value, the regenerative braking cooperation control is ended to prevent the brake fluid supplied to the brake cylinder 71 from being bypassed to the reservoir tank 40 (S107).

Accordingly, the brake fluid amount supplied to the brake cylinder 71 is sustained in a stable level to secure a stable braking force.

In a condition in which the regenerative braking cooperation control has ended, it is determined whether a reset condition is satisfied or not by detecting the operation of the brake pedal and the pressure of the master cylinder 30 in S109.

If the operation of the brake pedal and the pressure of the master cylinder 30 satisfy the reset condition in S109, the accumulated brake fluid amount bypassed is reset and it is returned to an earlier stage (S110).

The reset condition is satisfied if the brake pedal is off or the stroke increase amount thereof is less than a predetermined value (2%) and a pressure in the master cylinder 30 is not formed for 2 seconds.

Accordingly, if a stable braking force cannot be formed through braking while the brake fluid is being bypassed by the regenerative braking cooperation control, the regenerative braking cooperation control is ended in the present invention to secure a stable braking force.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A braking control apparatus of a hybrid vehicle, comprising:
a master cylinder generating braking pressure in accordance with an operation of a brake pedal;
a first valve controlling brake fluid supplied to a brake cylinder from the master cylinder;
a second valve bypassing the brake fluid supplied to the brake cylinder to a reservoir tank so as to adjust a regenerative braking torque amount during regenerative braking cooperation control; and
a brake control portion finishing the regenerative braking cooperation control, when an accumulated amount of brake fluid amount bypassed to the reservoir tank through the second valve surpasses a predetermined value during the regenerative braking cooperation control.

2. The braking control apparatus of claim 1, wherein the predetermined value is a minimum amount that sustains the pressure in the brake cylinder

3. The braking control apparatus of claim 1, wherein the brake control portion closes the second valve so as to prevent the brake fluid supplied to the brake cylinder from being bypassed to the reservoir tank when the regenerative braking cooperation control is finished.

4. The braking control apparatus of claim 1, wherein the brake control portion determines the brake fluid amount bypassed to the reservoir tank by subtracting a fluid consumption amount corresponding to a pressure increase point of the brake cylinder from a fluid consumption amount corresponding to a pressure decrease point of the brake cylinder.

5. The braking control apparatus of claim 1, wherein the brake control portion resets the accumulated amount of the brake fluid amount when the brake pedal is released and a predetermined time elapses.

6. The braking control apparatus of claim 5, wherein the brake control portion resets the accumulated amount of the brake fluid amount when a stroke increase amount of the brake pedal is less than a predetermined value.

7. A braking control method of a braking control apparatus for a hybrid vehicle, comprising:
accumulating a brake fluid amount bypassed to a reservoir tank during regenerative braking cooperation control performed by a brake demand;
finishing the regenerative braking cooperation control when the accumulated brake fluid amount surpasses a predetermined value; and
resetting the accumulated brake fluid amount when a brake pedal is released and a predetermined time elapses.

8. The braking control apparatus of claim 7, wherein the braking control apparatus comprises:
a master cylinder generating braking pressure in accordance with an operation of the brake pedal;
a first valve controlling brake fluid supplied to a brake cylinder from the master cylinder;
a second valve bypassing the brake fluid supplied to the brake cylinder to the reservoir tank so as to adjust a regenerative braking torque amount during the regenerative braking cooperation control; and
a brake control portion finishing the regenerative braking cooperation control, when the accumulated brake fluid amount bypassed to the reservoir tank through the second valve surpasses the predetermined value during the regenerative braking cooperation control.

9. The braking control apparatus of claim 8, wherein the predetermined value is a minimum amount that sustains the pressure in the brake cylinder

10. The braking control method of claim 8, wherein the bypassed brake fluid amount is determined by subtracting a fluid consumption amount corresponding to a pressure increase point of the brake cylinder from a fluid consumption amount corresponding to a pressure decrease point of the brake cylinder.

11. The braking control method of claim 8, wherein the brake control portion closes the second valve so as to prevent the brake fluid supplied to the brake cylinder from being bypassed to the reservoir tank when the regenerative braking cooperation control is finished.

12. The braking control apparatus of claim 8, wherein the brake control portion resets the accumulated brake fluid amount when a stroke increase amount of the brake pedal is less than a predetermined value.
